(19) United States
(12) Patent Application Publication
(10) Pub. No.: US 2026/0242299 A1
(43) Pub. Date: Aug. 20, 2026

(54) Method for Obtaining at Least One Ceramic Component by Joining at Least Two Ceramic SIC Preforms and Ceramic Components Obtained by Said Method

(71) Applicant: CeramTec GmbH, Plochingen (DE)

(72) Inventors: Pascal Hettich, Karlsruhe (DE); Martin Keim, Löchgau (DE); Jan Rudolf, Wendlingen (DE)

(21) Appl. No.: 19/164,651

(22) PCT Filed: Feb. 28, 2024
(86) PCT No.: PCT/EP2024/055091

§ 371 Date: Sep. 12, 2025

(30) Foreign Application Priority Data
Mar. 15, 2023 (EP) 23162081.6

(51) Int. Cl. C04B 37/00

(52) U.S. Cl. CPC C04B 37/008; C04B 2235/3826; C04B 2235/77; C04B 2237/083; C04B 2237/365; C04B 2237/61; C04B 2237/708

(57) ABSTRACT

Provided is a method for obtaining at least one ceramic component by joining at least two SiC preforms:
providing at least two porous SiC preforms, such as green or coked parts, each having at least one joining surface;
applying a joining slurry to the joining surfaces, the joining slurry comprising
40-to 80 wt % of at least one binding agent,
2-to 20 wt % of silicon carbide particles with a particle size D₅₀ of 10 to 20 μm
8-to 25 wt % of silicon carbide particles with a particle size D₅₀ of 1 to 10 μm,
10-to 30 wt % of carbon black,
wherein the sum of all ingredients always adds up to 100 wt %;
pressing the joining surfaces of the at least two SiC preforms together;
drying the at least two SiC preforms; and
heating the at least two SiC preforms.

### CROSS-REFERENCE TO RELATED APPLICATIONS

This application is the United States national phase of International Patent Application No. PCT/EP 2024/055091 filed Feb. 28, 2024, and claims priority to European Patent Application No. 23162081.6 filed Mar. 15, 2023, the disclosures of each of which are hereby incorporated by reference in their entireties.

### BACKGROUND

### Technical Field

The present disclosure refers to a method for obtaining at least one SiSiC ceramic component by joining at least two SiC preforms during infiltration with liquidous silicon (Si).

### Technical Considerations

Ceramic substrates or components are used in different technical areas, such as electronic industries, automotive industry and in medicinal industry. Due to the requirements in respect to hardness, chemical resistance and heat resistance silicon carbide (SIC) is used for ceramic substrates. To produce such a ceramic component, for example, a molded body made from a carbon-containing starting material can be subjected to a siliconization process in which the carbon is reacted with externally supplied silicon to form silicon carbide and, where appropriate pore networks which are present or formed in the molded body are filled with pure silicon. In the latter case, in which the pores of a molded body are infiltrated with silicon, a molded body of silicon infiltrated silicon carbide (SiSiC) is obtained, which is characterized by the fact that it has practically no residual porosity.

Larger ceramic substrates or components can be obtained by joining two or more smaller compounds or preforms by joining. This can include glueing with polymeric adhesives, such as epoxide adhesives, or soldering with metals or inorganic solders, i.e., glass. A disadvantage of the non-material bonding described above is a non-sufficient temperature stability, mechanical or chemical stability of the joining seam.

EP 3 599 229 B1 discloses reaction joined ceramic components consisting of two structural elements and having a joining seam made of a material with essentially the same or very similar properties as the material of the ceramic components or pre-bodies to be joined. The material of the joining seam consists of 30 vol % silicon carbide and at least 8 vol % silicon. At least one of the ceramic components to be joined comprises at least one cavity that is at least partially filled with silicon and/or a silicon alloy. The cavity adjoins the material of the joining seam or the silicon in the cavity adjoins at least partially the material of the joining seam. Thus, the cavities provided in the ceramic components are filled with silicon and can be seen as a type of storage space for silicon that is subsequently used for material-to-material bonding of the ceramic components to the joining seam.

DE 10 2011 007 815 B4 describes a process for obtaining a ceramic compound, wherein two pre-bodies are formed from a carbon composite with a matrix of amorphous and porous carbon, the two pre-bodies are bonded to each other by a bonding surface by providing and hardening a bonding paste containing silicon carbide and a polymer adhesive and subsequent siliconizing of the pre-bodies to a compound.

Ceramic compounds may also be obtained by 3D printing, as for example described in WO 2019/063833 A1 or WO 2018/206250 A1. However, a disadvantage of the printing method is that the print volume in 3D printing is limited by the design of the printer. This means, for example, that particularly large parts cannot be realized using 3D printing. Furthermore, SiSiC from 3D printing has a coarser SiC grain size and a higher Si content. Both factors reduce the mechanical properties, and have an influence on the electrical properties.

### SUMMARY

The object of the present disclosure was to provide a joining method that enables the combination of not infiltrated SiC preforms to form a joined SiSiC component after infiltration with Si, or to provide a joining method wherein porous, non-infiltrated parts made of SiC, so called SiC preforms, can be joined during Si infiltration to form a larger SiSiC component. The SiC preforms can be obtained by several manufacturing methods, for example pressing, slip casting, tape casting, 3D printing and/or extrusion to form a green body which can additionally be shaped by machining. In some non-limiting embodiments, the green parts may be heated up to 800 to 1250° C. to get coked parts to provide better mechanical stability for machining and/or for the infiltration step. In some non-limiting embodiments, in this context a joining slurry is required, which remains at the joining zone in the case of highly coarse-pored components and is not drawn into the component.

Accordingly, in some non-limiting embodiments, a method for obtaining at least one SiSiC ceramic component by joining at least two SiC preforms is provided, the method comprising the following steps:
providing at least two porous SiC preforms, such as green or coked parts, each having at least one joining surface;
providing a joining slurry comprising
   40-80 wt %, preferably 50-70 wt % of at least one binding agent,
   2-20 wt %, preferably 5-18 wt %, more preferably 8-15 wt % of silicon carbide particles with a particle size D50 (DIN EN 725-5, ISO 13320) of 10-20 μm, preferably D50 of 11-18 μm, more preferably D₅₀ of 11-16 μm,
   8-25 wt %, preferably 9-20 wt %, more preferably 10-15 wt % of silicon carbide particles with a particle size D₅₀ (DIN EN 725-5, ISO 13320) of 1-10 μm, preferably D₅₀ of 2-8 μm, more preferably D₅₀ of 2-5 μm,
   10-30 wt %, preferably 12-20 wt %, more preferably 13-18 wt % of carbon black,
   wherein the sum of all ingredients always adds up to 100 wt %;
pressing the joining surfaces of the at least two SiC preforms together;
drying the at least two SiC preforms; and
heating up the at least two SiC preforms, whereby Si is infiltrated into the SiC preforms comprising the dried joining slurry to obtain the materially bonded silicon-silicon carbide (SiSiC) ceramic component.

The present method allows joining of at least two SiC preforms for providing a SiSiC ceramic component. A joining slurry or paste is applied to the parts to be joined. This is characterized by an appropriate working time and consistency. As will be described in more detail below, the joining slurry comprises the following components: SiC particles with a bimodular or a trimodular particle distribution, carbon black, another carbon source as binding agent, and if required a solvent for adapting the viscosity of the joining slurry. To reduce the formation of pores, a centrifugal mixing device is used for mixing the slurry ingredients. The joining slurry promotes a material-to-material bonding of the two ceramic preforms.

The joining slurry is placed on the joining surface of at least one of the at least two SiC preforms to be joined to the larger component. Subsequently, the component has to be dried. Drying is sufficient when the surface of the slurry no longer shows any tendency to stick. The compounds are then infiltrated with Si, which results in a material bond.

The SiC preforms joined according to the present method are porous body comprising silicon, carbon, and/or silicon carbide.

### BRIEF DESCRIPTION OF THE DRAWINGS

The solution is now explained in more detail with reference to the examples and figures.

FIG. 1 shows a final ceramic component obtained in a first non-limiting embodiment according to the disclosure;

FIG. 2 shows a ceramic component obtained by joining two ceramic SiC preforms without joining slurry;

FIG. 3 is a microscopic view of a joining seam in a final SiSiC ceramic component;

FIG. 4A shows joining seam in a component according to a second non-limiting embodiment according to the disclosure;

FIG. 4B shows enlargement of the joining seam of FIG. 4A;

FIG. 5 shows a non-Si infiltrated joined SiSiC ceramic component obtained by joining a 3D printed SiC ceramic compound and a (standard) SiC preform.

### DETAILED DESCRIPTION

In some non-limiting embodiments of the present method, at least one of the SiC preforms is obtained by 3D-print having at least one joining surface. Thus, the present method also allows joining a 3D printed SiC preform with another 3D printed SiC preform or a SiC preform obtained by conventional non-printing methods. In this case, the joining slurry or paste is applied to the parts to be joined. The joining slurry is applied to contours of the SiC preform, e.g., by a spatula, and to flat surfaces of the SiC preform, e.g., by screen printing or other methods. Due to the complexity of 3D printed compounds, they can be embedded in a filler before they are subjected to pressure to avoid breakage if subjected to axial force.

The method according to the present disclosure has several advantages:
possibility of creating components from different SiC preforms to achieve the desired local technical properties; reduction of milling times and material savings;
complex (support) structures can be mapped by 3D printing. Where the technical properties require it, conventional SiC preforms can be used. This means, for example, that the functional surface and the complete support structure do not have to be milled out of a large block;
creation of SiC preforms which exceed the printing volume of the printer or which cannot be created by means of 3D for structural reasons; and/or
higher utilization of the print volume possible. Since the component can be printed in smaller parts and then assembled. This allows a higher packing density of the components in the job box.

As mentioned, SiSiC ceramic compounds obtained by using 3D printed preforms can have a coarser SiC grain size compared to conventionally obtained SiC preforms. Thus, SiC ceramic preforms obtained by 3D-print have a density in not infiltrated state of 1.3 to 3.0 g/cm³, preferably 1.5 to 2.5 g/cm³, more preferably 1.7 to 2.2 g/cm ³. The density is measured by the Archimedes method and/or geometrically.

In some non-limiting embodiments, the 3D printing method for obtaining SiC preforms is for example described in WO 2018/206250 A1, incorporated by reference herein. The 3D print method described therein is based on a moulded body from a composite material (such as SiC) that is built stepwise from a plurality of layers by means of powder bed printing or binder jetting with a layer thickness of 50 to 250 μm.

In some non-limiting embodiments of the production of SiC preforms by 3D print, various starting compositions are possible, preferably 80-98 wt % SiC and 2-20 wt % C. In some non-limiting embodiments, the primary SiC grains in the SiC preforms used have an average grain size of 25 to 60 μm, preferably 40 to 55 μm.

In order to fix the bottom layer required for the moulded body, a liquid fixing component comprising or consisting of a binder or a mixture of binder and hardener is used. The application may be carried out, for example, by means of a print head. The fixing component should preferably wet the powder well so that the organic material is distributed homogeneously. Consolidation of the printed areas in the layer can be done either by removing the volatile parts of the fixing component and/or by thermal and/or light-induced cross-linking (e.g., with an IR or UV lamp). After their consolidation a further layer of Ceramic powder is applied. The fixing component is applied and consolidated according to the required next layer of the moulding. The process is repeated until the moulding is built up according to the layer model. The infiltration of the SiC preform obtained is performed with silicon (Si).

In some non-limiting embodiments, the binder used in the 3D printing process can be prepared by thermal and/or light-induced cross-linking, for example by irradiation of large areas or points with an IR or UV lamp. UV curing components can be radical or cationic curing UV systems or a mixture of both, e.g., acrylates, epoxies, enol ethers, and/or vinyls. The thermally curing binder may be a component that is dried over a heat source and/or reaction. Exemplary components are phenolic resins, furan resins, epoxy resins, graphite resins, starch, sugar and/or cellulose solutions. The binder can also be on an inorganic basis, such as water glass. Preferred binders are phenolic resins.

In some non-limiting embodiments, the SiC preforms manufactured by 3D print have a grain size of 25 to 60 μm, preferably 40 to 55 μm and a 4-point bending strength of up to 250 MPa. The 3D-printed SiC preforms preferably have a structure in which the structure of individual layers in the microstructure is no longer visually recognizable at a vertical cut edge of the component, for example by means of light microscopy or scanning electron microscopy.

As indicated, it is of an advantage if the 3D printed SiC preform is embedded in a filling material for avoidance and protection against breaking when applying pressure. A suitable filling material may be a polymer granulate, sand and/or SiO₂ powder.

In some non-limiting embodiments, the joining slurry used in the present method comprises:
50-70 wt % of a binding agent,
5-18 wt % of silicon carbide particles with a particle size D₅₀ (DIN EN 725-5, ISO 13320) of 10-20 μm, preferably D₅₀ of 11-18 μm, more preferably D₅₀ of 11-16 μm,
9-20 wt % of silicon carbide particles with a particle size D₅₀ (DIN EN 725-5, ISO 13320) of 1-10 μm, preferably D₅₀ of 2-8 μm, more preferably D₅₀ of 2-5 μm,
12-20 wt % of carbon black,
Wherein in some non-limiting embodiments the sum of all ingredients always adds up to 100 wt %.

In some non-limiting embodiments, the joining slurry used in the present method comprises:
50-70 wt % of a binding agent,
8-15 wt % of silicon carbide particles with a particle size D₅₀ (DIN EN 725-5, ISO 13320) of 10-20 μm, preferably D₅₀ of 11-18 μm, more preferably D₅₀ of 11-16 μm,
10-15 wt % of silicon carbide particles with a particle size D₅₀ (DIN EN 725-5, ISO 13320) of 1-10 μm, preferably D₅₀ of 2-8 μm, more preferably D₅₀ of 2-5 μm,
13-18 wt % of carbon black,
Wherein in some non-limiting embodiments the sum of all ingredients always adds up to 100 wt %.

In some non-limiting embodiments, the joining slurry comprises:
40-80 wt %, preferably 50-70 wt % of a binding agent,
2-20 wt %, preferably 5-18 wt %, more preferably 8-15 wt % of silicon carbide particles with a particle size D₅₀ of 30-65 μm, preferably D₅₀ of 35-60 μm, more preferably D₅₀ of 40-55 μm,
2-20 wt %, preferably 5-18 wt %, more preferably 8-15 wt % of silicon carbide particles with a particle size D₅₀ of 10-20 μm, preferably D₅₀ of 11-18 μm, more preferably D₅₀ of 11-16 μm, and/or
8-25 wt %, preferably 9-20 wt %, more preferably 10-15 wt % of silicon carbide particles with a particle size D₅₀ of 1-10 μm, preferably D₅₀ of 2-8 μm, more preferably D₅₀ of 2-5 μm,
10-30 wt %, preferably 12-20 wt %, more preferably 13-18 wt % of carbon black,
Wherein in some non-limiting embodiments the sum of all ingredients always adds up to 100 wt %.

In some non-limiting embodiments, the joining slurry comprises:
40-80 wt %, preferably 50-70 wt % of a binding agent,
1-20 wt %, preferably 4-15 wt %, more preferably 6-10 wt % of silicon carbide particles with a particle size D₅₀ of 30-65 μm, preferably D₅₀ of 35-60 μm, more preferably D₅₀ of 40-55 μm, and
1-20 wt %, preferably 4-15 wt %, more preferably 6-10 wt % of silicon carbide particles with a particle size D₅₀ of 10-20 μm, preferably D₅₀ of 11-18 μm, more preferably D₅₀ of 11-16 μm,
8-25 wt %, preferably 9-20 wt %, more preferably 10-15 wt % of silicon carbide particles with a particle size D₅₀ of 1-10 μm, preferably D₅₀ of 2-8 μm, more preferably D₅₀ of 2-5 μm,
10-30 wt %, preferably 12-20 wt %, more preferably 13-18 wt % of carbon black,
wherein in some non-limiting embodiments the sum of all ingredients always adds up to 100 wt %.

In some non-limiting embodiments, the joining slurry comprises:
40-80 wt %, preferably 50-70 wt % of a binding agent,
2-20 wt %, preferably 5-18 wt %, more preferably 8-15 wt % of silicon carbide particles with a particle size D₅₀ of 30-65 μm, preferably D₅₀ of 35-60 μm, more preferably D₅₀ of 40-55 μm,
8-25 wt %, preferably 9-20 wt %, more preferably 10-15 wt % of silicon carbide particles with a particle size D₅₀ of 1-10 μm, preferably D₅₀ of 2-8 μm, more preferably D₅₀ of 2-5 μm,
10-30 wt %, preferably 12-20 wt %, more preferably 13-18 wt % of carbon black,
wherein in some non-limiting embodiments the sum of all ingredients always adds up to 100 wt %.

In some non-limiting embodiments, the joining slurry comprises:

50-70 wt % of a binding agent,
5-18 wt % of silicon carbide particles with a particle size D₅₀ of 30-65 μm, preferably D₅₀ of 35-60 μm, more preferably D₅₀ of 40-55 μm,
5-18 wt % of silicon carbide particles with a particle size D₅₀ of 10-20 μm, preferably D₅₀ of 11-18 μm, more preferably D₅₀ of 11-16 μm, and/or
9-20 wt % of silicon carbide particles with a particle size D₅₀ of 1-10 μm, preferably D₅₀ Of 2-8 μm, more preferably D₅₀ of 2-5 μm,
12-20 wt % of carbon black,
wherein in some non-limiting embodiments the sum of all ingredients always adds up to 100 wt %.

In some non-limiting embodiments, the joining slurry comprises:
50-70 wt % of a binding agent,
4-15 wt % of silicon carbide particles with a particle size D₅₀ of 30-65 μm, preferably D₅₀ of 35-60 μm, more preferably D₅₀ of 40-55 μm, and
4-15 wt % of silicon carbide particles with a particle size D₅₀ of 10-20 μm, preferably D₅₀ of 11-18 μm, more preferably D₅₀ of 11-16 μm,
9-20 wt % of silicon carbide particles with a particle size D₅₀ of 1-10 μm, preferably D₅₀ of 2-8 μm, more preferably D₅₀ of 2-5 μm,
12-20 wt % of carbon black,
wherein in some non-limiting embodiments the sum of all ingredients always adds up to 100 wt %.

In some non-limiting embodiments, the joining slurry comprises:
50-70 wt % of a binding agent,
5-18 wt % of silicon carbide particles with a particle size D₅₀ of 30-65 μm, preferably D₅₀ of 35-60 μm, more preferably D₅₀ of 40-55 μm,
9-20 wt % of silicon carbide particles with a particle size D₅₀ of 1-10 μm, preferably D₅₀ of 2-8 μm, more preferably D₅₀ of 2-5 μm,
12-20 wt % of carbon black,
wherein in some non-limiting embodiments the sum of all ingredients always adds up to 100 wt %.

In some non-limiting embodiments, the joining slurry comprises:
50-70 wt % of a binding agent,
8-15 wt % of silicon carbide particles with a particle size D₅₀ of 30-65 μm, preferably D₅₀ of 35-60 μm, more preferably D₅₀ of 40-55 μm,
8-15 wt % of silicon carbide particles with a particle size D₅₀ of 10-20 μm, preferably D₅₀ of 11-18 μm, more preferably D₅₀ of 11-16 μm, and/or
10-15 wt % of silicon carbide particles with a particle size D₅₀ of 1-10 μm, preferably D₅₀ of 2-8 μm, more preferably D₅₀ of 2-5 μm,
13-18 wt % of carbon black,
wherein in some non-limiting embodiments the sum of all ingredients always adds up to 100 wt %.

In some non-limiting embodiments, the joining slurry comprises:
50-70 wt % of a binding agent,
8-15 wt % of silicon carbide particles with a particle size D₅₀ of 30-65 μm, preferably D₅₀ Of 35-60 μm, more preferably D₅₀ of 40-55 μm,
8-15 wt % of silicon carbide particles with a particle size D₅₀ of 10-20 μm, preferably D₅₀ of 11-18 μm, more preferably D₅₀ of 11-16 μm,
10-15 wt % of silicon carbide particles with a particle size D₅₀ of 1-10 μm, preferably D₅₀ of 2-8 μm, more preferably D₅₀ of 2-5 μm,
13-18 wt % of carbon black,
wherein in some non-limiting embodiments the sum of all ingredients always adds up to 100 wt %.

In some non-limiting embodiments, the joining slurry comprises:
50-70 wt % of a binding agent,
8-15 wt % of silicon carbide particles with a particle size D₅₀ of 30-65 μm, preferably D₅₀ of 35-60 μm, more preferably D₅₀ of 40-55 μm,
10-15 wt % of silicon carbide particles with a particle size D₅₀ of 1-10 μm, preferably D₅₀ of 2-8 μm, more preferably D₅₀ of 2-5 μm,
13-18 wt % of carbon black,
wherein in some non-limiting embodiments the sum of all ingredients always adds up to 100 wt %.

It is to be noted that the particle size of the silicon carbide particle is adapted to the ceramic material of the ceramic preforms to be bonded and the silicon carbide particles may be provided in a bimodular or trimodular distribution, but preferably in a bimodular size distribution. This has the advantage that the joining slurry imitates the material of the SiC preforms to be joined, i.e., the material properties of the joining slurry are similar to the material properties of the surrounding SiC preforms.

The binding agent used in the joining slurry is preferably an organic material that cokes or pyrolyzes at or below the infiltration temperature of the ceramic material; i.e., the organic material is converted to carbon during the coking process. The binding agent can be from renewable organic sources, such as starch or sugar, providing an ecological alternative to the commonly used phenolic resins or polymers. The binding agent may be added as a solution or suspension, preferably as an aqueous solution or suspension.

In some non-limiting embodiments the joining slurry may also comprise or contain a solvent, preferably water, or a mixture of at least two solvents, for adjusting viscosity of the slurry. In most cases, water is added to the slurry preferably together with the binding agent as a solution or suspension. The amount of solvent, in particular water, in the joining slurry may be up to 20 wt %, such as 2-20 wt %.

In some non-limiting embodiments, the components of the joining slurry are mixed using the following mixing parameters: 80 sec at 400 rpm, 100 sec at 600 RPM, 120 sec at 800 rpm. This program is repeated 6-8 times. The mixing process is carried out under atmospheric pressure or in vacuum.

It is to be understood that the joining slurry can be heated up to a temperature of 150° C., such as room temperature (RT) to 150° C., preferably 40-100° C., more preferably 50-90° C. The heating or tempering of the joining slurry reduces the viscosity of the slurry and facilitates the application of the slurry on the ceramic component surface. The drying is applied for at least up to 6 hours, preferably more than 6 hours.

In some non-limiting embodiments, the areas of joining surface of the at least two SiC preforms may contain cavities which are supposed to remain as cavities after infiltration bonding. Therefore at least one of the at least two SiC preforms can provide cavities on the areas of joining surface. These cavities can be filled before infiltration with a filler material, preventing Si from entering the cavities, which does not react with the liquid Si based metal during infiltration of the at least two SiC preforms comprising the joining slurry. In some non-limiting embodiments, the filler material can be for example a paste based on boron nitride and can be removed from the cavity after the infiltration step preferred free of residues. The use of the filler material is important for inner cavities because due to capillary forces and the cooling behavior of Si the cavities otherwise may be filled with Si during infiltration.

In some non-limiting embodiments, the joining slurry is provided on one or both of the joining surfaces of the two ceramic preforms to be joined by spatula, screen printing, spraying and/or any other suitable method. The joining slurry is only placed onto those areas of the joining surface that are supposed to be bonded after infiltration with Si. On the surfaces of cavities with and without filler material no joining slurry is provided.

In some non-limiting embodiments, the joining slurry is placed on the joining surfaces in such an amount that the slurry layer has a thickness of up to 200 μm, such as 10-200 μm, preferably 30-150 μm, or more preferably 50-100 μm.

After providing the joining slurry on the surface to be bonded said joining surfaces of the at least two compounds are placed on top of each other so that the joining surfaces are in contact with each other. In some non-limiting embodiments, the joining surfaces of the at least two SiC preforms may be pressed together for at least 3 hours, preferably more than 5 hours. In some non-limiting embodiments, the joining surfaces of the at least two SiC preforms are compressed or pressed together at a pressure of at least 0.3 MPa (3 bar), preferably of at least 0.5 MPa (5 bar) for at least 3 hours, preferably for at least 5 hours.

In some non-limiting embodiments, in a subsequent step, the at least two ceramic SiC preforms and the joining slurry are dried at temperature(s) of 20° C. (preferably room temperature) to 150° C., preferably 40 to 100° C., more preferably 50 to 90° C. The drying is sufficient when the surface of the joining slurry shows no adhesion tendency.

In some non-limiting embodiments, the drying loss of the joining slurry (determined according to DIN 51078, DIN EN 51078) is 5-70 wt %, preferred 6-60 wt %, more preferred 8-50 wt % (drying parameter: drying temperature 105° C., shutdown criterion less than 1 mg weight loss in 120 s). Loss of ignition as determined according to DIN 51081, ISO 806 at 1000° C. in oxygen: 40-80 wt %, preferred 50-75 wt %, more preferred 60-75 wt. %.

By using the joining slurry as described, SiSiC is formed in the joining seam instead of a pure Si layer. Thus, in some non-limiting embodiments, the joining seam bonding the at least two SiC preforms is preferably almost chemically identical to the surrounding material of the bulk material of the obtained SiSiC component. However, there may be a different amount of silicon.

In some non-limiting embodiments, the joining seam may comprise up to 50 vol % silicon, preferably up to 30 vol %, such as 8-30 vol %, while the amount of silicon in the ceramic compound surrounding the joining seam is not more than 25 vol %, preferably 10-20 vol %.

In some non-limiting embodiments the material of the joining seam comprises at least 50 vol % silicon carbide and at least 8 vol % silicon, or 50 to 92 vol % silicon carbide and 8 to 50 vol % silicon, or 70 to 92 vol % silicon carbide and 8 to 30 vol % silicon, wherein the sum of all phases always adds up to 100 vol %.

The silicon content in the joining seam is determined by image analysis. Accordingly, the area of the joining seam to be analysed is marked in a first step. Subsequently, the silicon is marked by means of a grey value range. A software (Stream from Olympus) determines the portion or percentage of pixels in the marked area which corresponds to the silicon content in the analysed area.

In some non-limiting embodiments, the thickness of the joining seam is similar to the thickness of the joining slurry layer and is up to 200 μm, preferably up to 100 μm, such as 10-200 μm, preferably 30-150 μm, more preferably 50-100 μm.

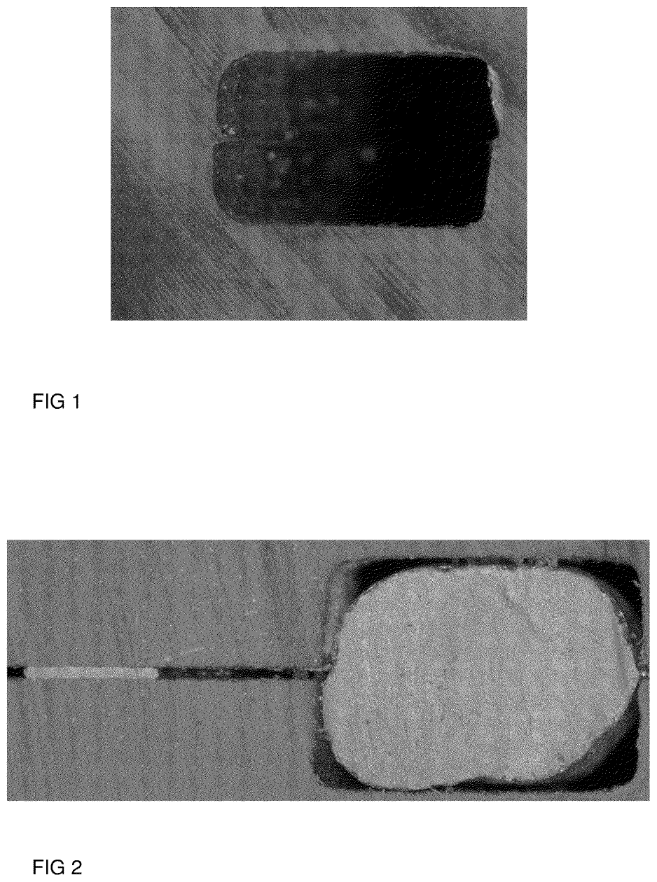

This joining and drying process provides a porous SiC component which can be infiltrated with liquid Si to fill the pores of the ceramic material and form a SiSiC component (see FIG. 1).

Thus, the present method allows for providing a SiSiC ceramic component
wherein at least two SiC preforms are joined together by materially bonding, and
wherein the at least two SiC preforms are infiltrated with Si comprising the dried joining slurry.

In some non-limiting embodiments, the present method allows for providing a SiSiC ceramic component
wherein at least two SiC preforms joined together by materially bonding,
wherein at least one of the SiC preforms is a porous SiC ceramic preform obtained by 3D print, and
wherein the porous SiC preforms are infiltrated with Si comprising the joining slurry to bond the at least two SiC preforms.

Using the present joining slurry SiSiC is formed in the joining seam instead of Si layers and a material-to-material bond is formed. In case of SiSIC materials, the SiC particles which are present before the Si infiltration are called primary SiC, SiC grains formed during infiltration from a reaction of carbon located in the preform or joining slurry with the infiltrating liquidous Si is called secondary SiC. The joining seam of the joint SiSiC component comprises primary SiC out of the joining slurry. Additionally secondary SiC is formed from the carbon source of the joining slurry and the liquid Si from the infiltration step and a joining seam with the same phases as the SiSiC surrounding is formed. The bounded material shows the advantageous feature of material properties comparable to the bulk material.

In some non-limiting embodiments, the ceramic component obtained by any of the methods described herein reaches a bending strength of at least 65 %, preferred at least 75 %, more preferred at least 80 % and most preferred at least 85 % of the mechanical strength of the monolithic ceramic bulk material; i.e., ceramic material without joining seam. The bending strength was determined according to DIN 843-1, 843-5 ISO 14704, ASTM C1161-13 using a 4 point measurement, using bending bars made of two vertically in the middle joined bars.

In contrast, in a joint component containing Si only in the joining seam, less than 50 % of the mechanical strength can be obtained. If a glue is used for joining, carbon from the glue can react to secondary SiC on the interface between SiC preform and the joining seam. The joining seam still consists mainly from Si as the secondary SiC formed with the carbon sourced from the glue is decreasing with the distance from the interface with the SiC preforms to the middle of the joining seam. Therefore, less than 60 % of the mechanical strength of the bulk material can be obtained when using a glue for joining of the at least two SiC preforms.

The ceramic components as obtained by the present method can be used, i.e., in wafer handling systems (i.e., wafer tables), sensors, cooling systems, heat exchangers, collectors, and/or sensor frames.

### Example 1

For joining two SiC preforms a joining slurry is used, which comprises SiC particles, carbon black and another carbon source such as a polymer. The following is an example of the join slurry composition: Starch solution: 55 wt %, SiC powder with FEPA grit size F500: 14 wt %, SiC powder with a Federation of the European Producers of Abrasives (FEPA) grit size F1200: 10 wt %, Carbon black/Graphite: 14 wt %. This joining slurry is applied by screen printing or other processes.

### Example 2

The following is another example of the joining slurry composition: Starch solution: 62 wt %, SiC powder with FEPA grit size F500: 10wt %, SiC powder with FEPA grit size F1200: 10wt %, Carbon black/Graphite: 10 wt %, water 8 wt %. This joining slurry is applied by screen printing or other processes on the joining surface area of at least one of the SiC preforms.

### Example 3

The following is another example of the joining slurry composition: Starch solution: 50 wt %, SiC powder with FEPA grit size: 12wt %, SiC powder with FEPA grit size F1200: 16wt %, Carbon black/Graphite: 17 wt %, water 5 wt %. This joining slurry is applied by screen printing or other processes on the joining surface area of at least one of the SiC preforms.

The two SiC preforms are then pressed together for >5 hours at over 5 bar, and subsequently dried at 50-90° C. for >6 hours. This joining and drying process provides a porous SiC component which can be infiltrated with liquid Si to fill the pores of the ceramic material and form a SiSiC component.

By using a joining slurry, during the infiltration step SiSiC is formed in the joining seam instead of a pure Si layer. A material bond is created.

In contrast, when joining two ceramic SiC preforms without joining slurry, the joining seams can fill up completely with Si, and a materially bonded connection is not provided, as can best be seen in FIG. 2.

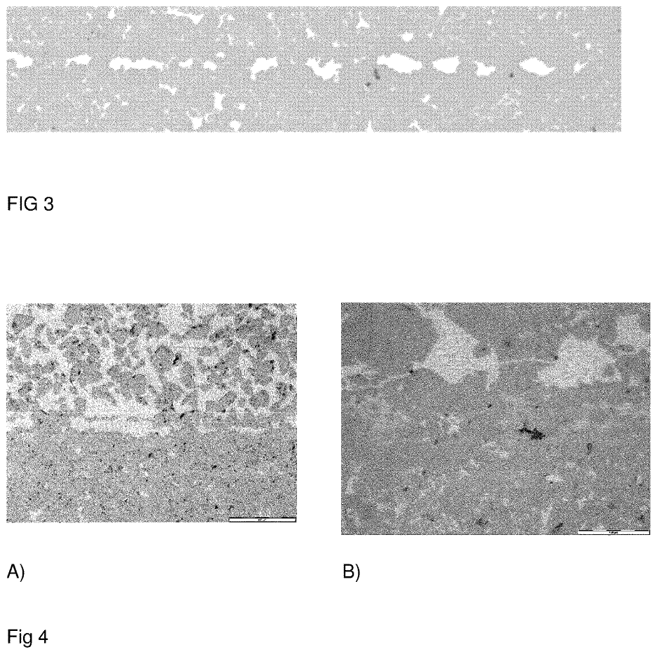

The microscopic picture of FIG. 3 shows the joining seam after Si infiltration bonding of two SiC preforms using the method of the present disclosure. The brighter areas reflect the areas of silicone (Si) within the joining seam. As apparent, the areas with more silicone are mostly aligned along the joining seam, and are partially interrupted by darker areas without almost no silicone. In the sample illustrated in FIG. 3, the joining seam comprises 8-30 vol % silicone, while the amount of silicon in the ceramic compound surrounding the joining seam is only 2-20 vol %.

### Example 4

For joining two SiC preforms a joining slurry is used, which comprises SiC particles, carbon black and another carbon source such as a polymer.

The following is an example of the joining slurry composition: Starch solution: 55 wt %, SiC powder with FEPA grit size F240 and/or F500: 14wt %, SiC powder with FEPA grit size F1200: 10wt %, Carbon black/Graphite: 14 wt %, water 7 wt %. This joining slurry is applied by screen printing or other processes on the joining surface area of at least one of the SiC preforms.

### Example 5

The following is another example of the joining slurry composition: Starch solution: 62 wt %, SiC powder with FEPA grit size F240 and/or F500: 10wt %, SiC powder with FEPA grit size F1200: 10wt %, Carbon black/Graphite: 10 wt %, water 8 wt %. This joining slurry is applied by screen printing or other processes on the joining surface area of at least one of the SiC preforms.

### Example 6

The following is another example of the joining slurry composition: Starch solution: 50 wt %, SiC powder with FEPA grit size F240 and/or F500: 12wt %, SiC powder with FEPA grit size F1200: 16wt %, Carbon black/Graphite: 17 wt %, water 5 wt %. This joining slurry is applied by screen printing or other processes on the joining surface area of at least one of the SiC preforms.

The two SiC preforms are then pressed together for >5 hours at over 5 bar, and subsequently dried at 50-90° C. for >6 hours. This joining and drying process provides a porous SiC component which can be infiltrated with liquid Si to fill the pores of the ceramic material and form a SiSiC component.

FIGS. 4A and 4B show a joining seam in a component made of a 3D porous SiC preforms (upper image area) and conventionally manufactured porous SiC preform (lower image area) using a joining slurry of any of the Examples 4-6.

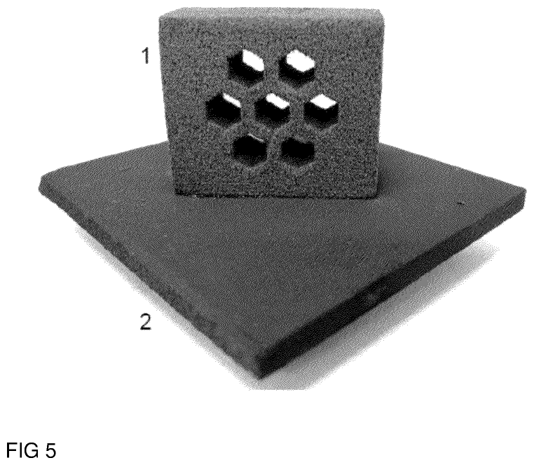

FIG. 5 shows a SiSiC ceramic component obtained by joining a 3D printed SiC ceramic compound (1) and a (standard) SiC preform (2).

This combination of 3D printed SiC ceramic compound and a standard SiC preform is used when the complexity is high and the geometry is difficult to produce economically using other manufacturing processes, and/or only a small number of components are required, e.g., prototype production. In those cases 3D printing is cheaper than a new mould.

The advantages of conventional manufacturing, on the other hand, are the better material properties and the lower manufacturing costs for higher quantities.

A combination 3D printed SiC ceramic compound and a standard SiC preform is therefore used in those cases, when a high level of complexity is required, the properties of the 3D-printed compound are too low or if the overall size of the component exceeds the volume of the 3D printer.

1. A method for obtaining at least one ceramic component by joining at least two SiC preforms:
providing at least two porous SiC preforms, each having at least one joining surface;
applying a joining slurry to each joining surface of the at least two preforms, the joining slurry comprising.
40-to 80 wt % of at least one binding agent,
2-to 20 wt % of silicon carbide particles with a particle size D₅₀ (DIN EN 725-5, ISO 13320) of 10 -10 to 20 μm,
8-to 25 wt % of silicon carbide particles with a particle size D₅₀ (DIN EN 725-5, ISO 13320) of 1-10 10 μm,
10-to 30 wt % of carbon black,
wherein the sum of all ingredients always adds up to 100 wt %;
pressing the joining surfaces of the at least two SiC preforms together;
drying the at least two SiC preforms; and
heating up the at least two SiC preforms, whereby Si is infiltrated into the SiC preforms comprising a dried joining slurry to obtain a materially bonded silicon-silicon carbide (SiSiC) ceramic component.

2. The method according to claim 1, wherein at least one of the SiC preforms is obtained by 3D-print, each having at least one joining surface.

3. The method according to claim 2, wherein at least one of the SiC preforms obtained by 3D-print has a density of 1.3 to 3.0 g/cm ³, before the infiltration with Si.

4. The method according to claim 2, wherein the 3D printed SiC preform is embedded in a filling material.

5. The method according to claim 1, wherein the joining slurry comprises:
50-to 70 wt % of the at least one binding agent,
5-to 18 wt % of silicon carbide particles with a particle size D₅₀ (DIN EN 725-5, ISO 13320) of 10 -10 to 20 μm,
9-to 20 wt % of silicon carbide particles with a particle size D₅₀ (DIN EN 725-5, ISO 13320) of 1-to 10 μm,
12-to 20 wt % of carbon black,
wherein the sum of all ingredients always adds up to 100 wt %.

6. The method according to claim 1, wherein the joining slurry comprises:
50-to 70 wt % of the at least one binding agent,
8-to 15 wt % of silicon carbide particles with a particle size D₅₀ (DIN EN 725-5, ISO 13320) of 10 to 20 μm,
10-to 15 wt % of silicon carbide particles with a particle size D₅₀ (DIN EN 725-5, ISO 13320) of 1-to 10 μm,
13-to 18 wt % of carbon black,
wherein the sum of all ingredients always adds up to 100 wt %.

7. The method according to claim 1, wherein the joining slurry comprises:
40-to 80 wt % of the at least one binding agent,
2-to 10 wt % of silicon carbide particles with a particle size D₅₀ (DIN EN 725-5, ISO 13320) of 30-to 65 μm, and/or
2-to 20 wt % of silicon carbide particles with a particle size D₅₀ (DIN EN 725-5, ISO 13320) of 10-to 20 μm,
8-to 25 wt % of silicon carbide particles with a particle size D₅₀ (DIN EN 725-5, ISO 13320) of 1-to 10 μm,
10-to 30 wt % of carbon black,
wherein the sum of all ingredients always adds up to 100 wt %.

8. The method according to claim 1, wherein the at least one binding agent of the joining slurry is an organic material.

9. The method according to claim 9, wherein the at least one binding agent of the joining slurry comprises starch or sugar.

10. The method according to claim 1, wherein the joining slurry further comprises at least one solvent or a mixture of at least two solvents, for adjusting viscosity of the slurry.

11. The method according to claim 10, wherein the amount of the solvent in the joining slurry is up to 20 wt %.

12. The method according to claim 1, wherein the slurry layer applied to the at least one joining surface has a thickness of up to 200 μm.

13. The method according to claim 1, wherein the joining surfaces of the at least two SiC preforms with the joining slurry are pressed together for at least 5 hours.

14. The method according to claim 1, wherein the drying of the SiC preforms pressed together is carried out at a temperature of 20° C. to 150° C.

15. The method according to claim 1, wherein the silicon carbide particles are provided in a bimodular size distribution.

16. The method according to claim 1, wherein the silicon carbide particles are provided in a trimodular size distribution.

17. The method according to claim 1, wherein the joining surfaces of the at least two SiC preforms are compressed or pressed together at a pressure of at least 0.3 MPa.

18. The method according to claim 1, further comprising filling at least one area of a joining surface of the at least two SiC preforms with a filler material before applying the joining slurry to the joining surfaces of the at least two SiC preforms, wherein the filler material is removed from the cavity after the heating of the at least two preforms and Si infiltration is completed.

19. The method according to claim 1, wherein the dried joining slurry forms a joining seam comprising up to 50 vol % silicon.

20. The method according to claim 19, wherein the material of the joining seam comprises at least 50 vol % silicon carbide and at least 8 vol % silicon.
